(19) United States
(12) Patent Application Publication
(10) Pub. No.: US 2011/0270631 A1
(43) Pub. Date: Nov. 3, 2011

(54) REMOTE HEALTHCARE DATA-GATHERING AND VIEWING SYSTEM AND METHOD

(75) Inventors: John E. Cambray, Belmont, NH (US); Daniel J. McCafferty, Chelmsford, MA (US); Jarongorn Manny Lertpatthanakul, Nashua, NH (US); Nelson Vicente, Selden, NY (US)

(73) Assignee: AMD Global Telemedicine, Inc., Chelmsford, MA (US)

(21) Appl. No.: 13/099,615

(22) Filed: May 3, 2011

Related U.S. Application Data
(60) Provisional application No. 61/330,597, filed on May 3, 2010.

(51) Int. Cl. G06Q 50/00

(52) U.S. Cl. 705/3

(57) ABSTRACT

A medical data collection method and system (10) for gathering medical data from an individual when the individual is located remotely from a healthcare professional. A computer device that includes an aggregation device (22) is used at the patient remote site (11) for collecting medical data/information from various medical devices (14) that can gather appropriate medical data. The aggregation device (22) sends the recorded medical data using a Service Oriented Architecture (SOA) web service/application (25) to a network 16. The information may be saved on a local or centralized data storage device (18) and/or stored to a patient's medical record. A healthcare provider (i.e. physician, physician's assistant, nurse or the like) (20) can access the medical data (25) in real time or from the optional data storage device via a connect manager or through a secure or unsecure connection in real time while the data is being captured from the patient or if the data is stored, at any time in the future using a personal computer or handheld device such as a personal computer, notebook, palm pilot, Iphone, Blackberry or the like that is capable of running a browser that can consume the medical record service (25) provided by the aggregation device (22).

### RELATED APPLICATION

This application claims priority to U.S. Provisional Patent Application No. 61/330,597 filed on May 3, 2010 entitled “Health Care Monitoring Systems And Methods”, which is incorporated fully herein by reference.

### TECHNICAL FIELD

The present invention relates to remote healthcare monitoring and assessment of individuals and more particularly, relates to the use of the internet and web-based programs to allow for the real-time display, capture and storage of patient medical data for remote review by healthcare professionals.

### BACKGROUND INFORMATION

Remote healthcare monitoring has become increasingly important and has benefits for both patients and healthcare professionals. Patients who live far away from hospitals, doctors and specialists often have a difficult time having access to health care and/or specialists. Those living in remote areas, such as in certain parts of Alaska, for example, cannot easily leave their village to gain access to routine or specialized healthcare. Aging and sick patients also are often not willing or able to make long drives to seek medical care. There is a need to allow these distant patients access to excellent medical care by creating a way for vital patient data, diagnostic and other health related information to be collected at remote sites by minimally skilled personnel and subsequently transferred to doctors and other healthcare professionals that may be hundreds or thousands of miles away. Chronically ill patients may need daily contact with a healthcare provider and this can often be accomplished in a home setting, which keeps patients out of hospitals longer and further reduces the costs associated with care.

A remote healthcare service could allow a doctor to see more patients, in less time, and could also allow the doctor to be able to communicate and consult with other healthcare professionals. The remote monitoring should also be accomplished without the need for specialized equipment or medical staff and without significant capital costs.

Current remote health care monitoring systems (often called telemedicine applications) run by means of proprietary video conferencing hardware and software. Videoconferencing requires that the doctor be available and connected while and at the same time as the patient is also available and connected. Videoconferencing also requires that the doctor have access to a video-conference examination room with expensive and vendor specific video conference equipment while they are treating a specific patient.

In order to operate such remote health monitoring systems, the teleconferencing video hardware and software must be configured for the specific patient data collection device (such as a stethoscope, ear canal inspection device, camera, EKG or the like). The data collection device must be interfaced with and to the video conferencing system.

When transmitting data from the healthcare monitoring device, the data is transmitted through the video conferencing system, in band, using all or part of the bandwidth of the video conferencing system. Medical data may include video, audio or text. This “in band” transmission of critical patient health data makes the video conferencing connection can be incompatible between systems and more complicated to manage. Moreover, the transmitting equipment must be either the same as or compatible with the receiving video conferencing system. Typically, video conferencing systems from different vendors are not compatible with one another thus forcing a doctor or other healthcare collaborator to have the same video teleconferencing system as on the patient end. Moreover, the use of video conferencing systems for telemedicine forces physicians to allocate financial and physical resources to acquiring, maintaining and housing a video conferencing system in their home or office—without which they cannot participate in telemedicine.

Very importantly, however, is the fact that with present day videoconferencing systems, once the consulting encounter is done, all of the data is lost without the proper equipment. However, recording an entire videoconference session requires enormous amounts of data storage and cannot be ported to an electronic medical record. There is no picture, recording or other data that can be re-examined at a later date and time or shared with a colleague for a 2nd opinion or consultation. Moreover, such prior art videoconference based telemedicine systems must be constantly upgraded, and require trained staff to operate.

Accordingly, what is needed is a telemedicine system and method which is easy to use, provides for a single aggregation device for use with any manufacturers' medical data collection device, which collects medical data and makes the medical data immediately available to a physician or other health care professional located remotely from the patient from whom the medical data is being collected or alternatively, that stores the medical data either locally or at a central location to be accessed and reviewed by one or more health care professionals simply having a browser equipped device connected to the Internet or Intranet.

It is important to note that the present invention is not intended to be limited to a system or method which must satisfy one or more of any stated objects or features of the invention. It is also important to note that the present invention is not limited to the preferred, exemplary, or primary embodiment(s) described herein. Modifications and substitutions by one of ordinary skill in the art are considered to be within the scope of the present invention.

### BRIEF DESCRIPTION OF THE DRAWINGS

These and other features and advantages of the present invention will be better understood by reading the following detailed description, taken together with the drawings wherein:

FIG. 1 is a schematic block diagram illustrating the various elements of the system according to the present invention;

FIG. 2 is a more detailed block diagram of the medical encounter system according to one embodiment of the present invention without a connect manager showing more detail of the aggregation device;

FIG. 3 is a more detailed block diagram of the medical encounter system according to another embodiment of the present invention with a connect manager;

FIG. 4 is a screen shot of a sample physician screen in accordance with one aspect of the present invention;

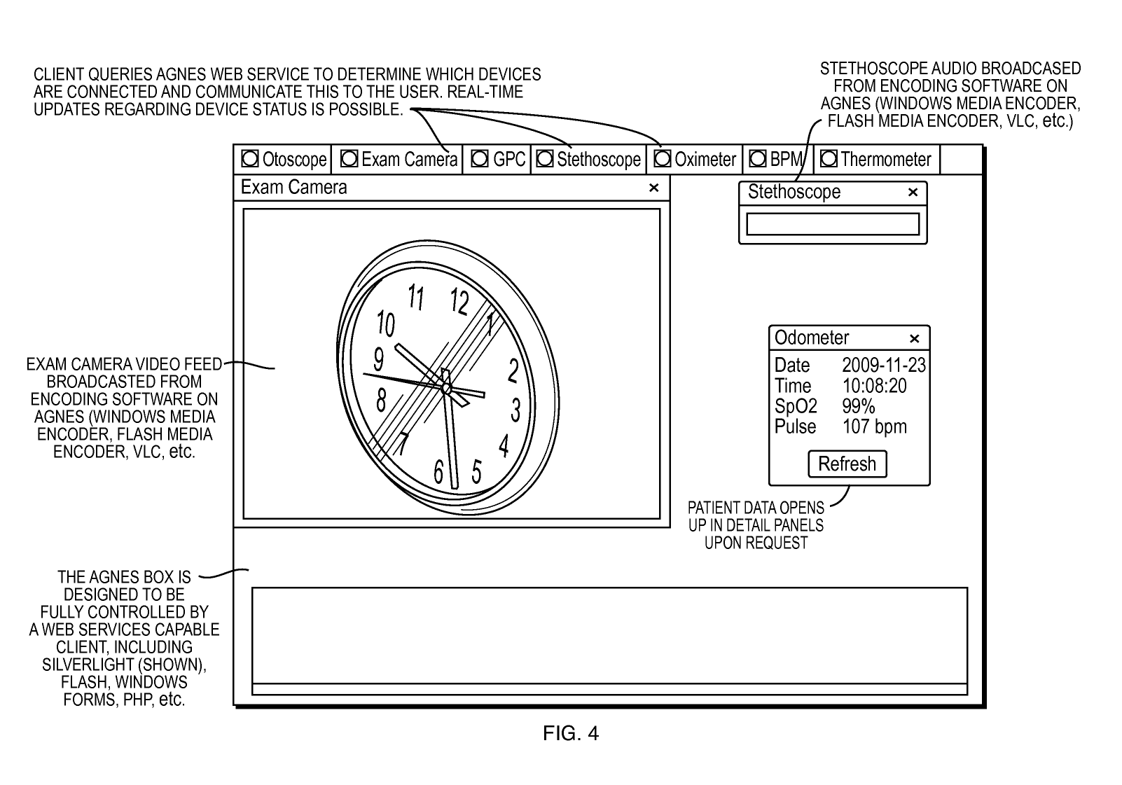

FIG. 5 is a schematic diagram showing the interactions between various devices and software aspects of the present invention; and

FIG. 6 is a block diagram of the kit embodiment of the present invention.

### DETAILED DESCRIPTION OF THE PREFERRED EMBODIMENTS

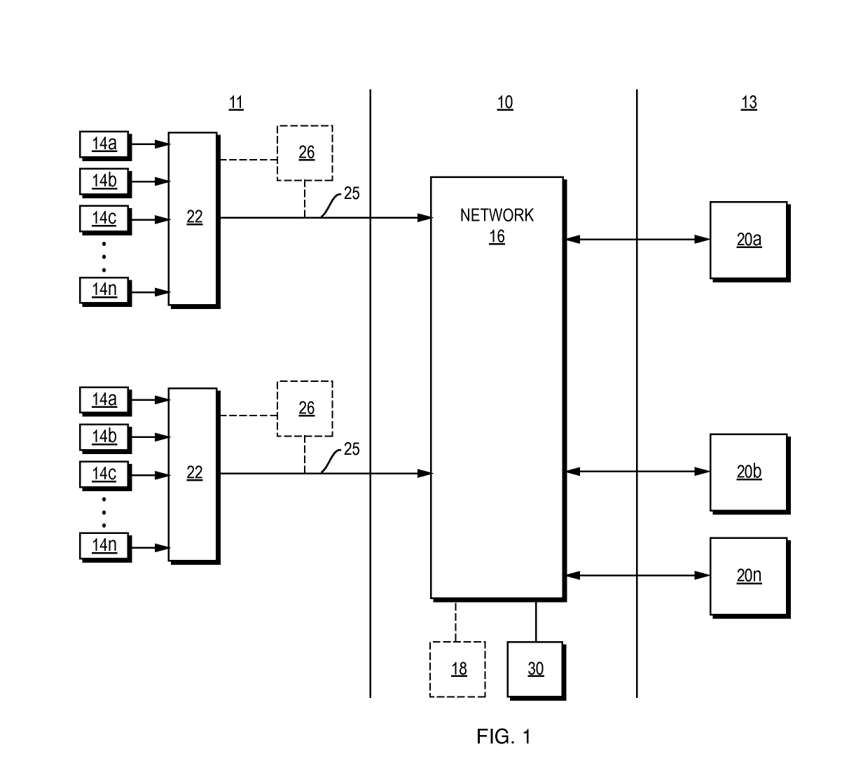

The present invention is an internet/intranet and browser based remote medical encounter system 10, FIG. 1 designed for healthcare data gathering and viewing. The medical encounter system 10 enables the collection of medical data from a client or patient 12 typically located at a site remote from a doctor, hospital or other healthcare professional (although this is not a limitation of the present invention) such as at a clinic, mobile health care, field site, home site or other site 11, through the use of one or more various medical data collection/examination devices 14a, 14b through 14n, that in turn are coupled (by wired or wireless connection) to an aggregation device 22

The aggregation device 22 is implemented as a web-services based application termed an SOA—Services Oriented Architecture service that is platform independent and can be run on nearly any device running a web server. The aggregation device 22 is preferably a PC or other computer controlled “platform” running appropriate software and that is configured to produce a “service” 25 containing the medical data received from a patient, and that can be “consumed” by any web browser or web application or other application, as will be described below. The service 25 containing the real time medical data received by the aggregation device 22 from the one or more various medical devices 14 may include textual data, still images or pictures, audio streams, video streams and the like, and that may be attached directly to the patient's electronic medical record (EMR).

The aggregation device 22 services can be consumed via a browser or in another embodiment, in an application wherein the service 25 can be consumed by an application dependent device such as a Blackberry®, Iphone®, Droid® or the like. The aggregation device can communicate in a variety of protocols including, for example, HTTP and HTTPS.

The aggregation device 22 makes use, as needed, of commercially available “adapters” to physically connect a medical device 14 with the aggregation device, which typically uses a USB port connection. For example, a medical device 14 providing a video signal or stream may utilize a composite video cable and accordingly, an adapter is required to physically interconnect the composite video cable to a USB port on the aggregation device 22. In addition, the aggregation device 22 will require a “driver” to effectuate the conversion. The invention that certain adapters may have a driver commercially available or alternative, one may have to be written, as is well known in the art.

In another embodiment, the medical data gathering devices 22 may communicate wirelessly with the aggregation device by means conforming to and utilizing a readily available wireless standard such as Bluetooth®, Zigbee® and the like depending on their configuration and bandwidth requirements.

Accordingly, the present invention provides such medical data capturing devices 22, which previously had no IP address and thus no possibility of a web based presence, with an single IP address (provided by the aggregation device 22) and therefore makes them network connectable. Moreover, providing their output in a SOA allows the consumer of these SOA service to query and otherwise interrogate the aggregation device 22 to determine what medical device 22 is connected, as will be explained in greater detail below.

The aggregation device 22 is connected through a wireless or wired connection, either directly or through one or more web application tier device 26, to an internet or intranet service 16.

The device 26 is preferably a computer, monitor, software, hardware or other like device, either physically separate or residing on the same hardware as the aggregation device 22, which consumes the web services 25 of the aggregation device 22 and in one embodiment, can display the results being transmitted from the connected and enabled medical device(s) 22. The device 26 may perform any formatting, logic, or other manipulation of the data received from the aggregation device 22 before connecting the data to viewer's web browser device 20. Alternatively, the device 26 allows a technician, clinician or the actual patient (whoever is “using” the medical data gathering device 14) to “view” or “hear” what medical data is being captured and transmitted by the medical device 14 through the aggregation device to insure a good, clear, quality medical data information and/or to reposition the medical data gathering device 14 under instruction from a physician, health care provider of other “viewer” 20 of the medical data.

In the preferred embodiment, the one or more physicians or other healthcare professionals 20 receive the medical data from the one or more medical devices 14 in real time, as the data is collected. Because the medical data is being provided in real-time and as a “service” over an Internet or Internet connection, multiple physicians or other health care providers may access the data simultaneously. For example, if one health care provider suspects a patient may have a skin condition which the Health Care provider is not completely familiar with, the first health care provider may arrange for a second health care provider, perhaps with more experience in a particular field, to access and view the medical data at the same time as the first healthcare provider is reviewing the medical data. This form of “collaborative” healthcare assessment is made possible by the fact that the present invention provides a consumable “service” 25 over a local or wide-area network which may be “consumed” by more than one “viewer”.

In an alternative embodiment, the medical data from the one or more medical devices 14 may be stored on a local or centralized data storage device 18. In the embodiment utilizing a storage device 18, care will have to be taken by the entity storing the medical data to make sure that all appropriate State and federal health care regulations, such as HIPPA, are complied with.

In the preferred embodiment, the one or more physicians or other health care professional 20 who are in turn connected through a wireless or wired connection to the internet or intranet 16 to the patient medical data received in real time, may access the medical data “service” 25 utilizing a browser or application driven device capable of consuming the received service 25. Alternatively, if the medical data is stored on a storage device 18, the physician or other health care professional 20 may review the data at any time they desire.

The medical devices 14a, 14b through 14n facilitate the collection of patient medical information or data. The medical devices 14 can collect video, audio or text data or two or more of these types of data. For example, the medical devices 14 may include nearly every type of medical data collection device available now or in the future such as, but not limited to, a camera, stethoscope, ear or nose scope, EKG machine, pulse meter, blood oxygen measurement device, thermometer or the like, and used to record medical information about a patient such as pulse rate, respiration rate, body temperature, body weight, blood glucose, ECG/EKG recordings, spirometry results, photographs of external or internal body features or a multitude of other medical indicators.

In one example, medical device 14a may monitor blood pressure, medical device 14b may monitor lung capacity and medical device 14c may monitor heart rate. It is contemplated by the current invention that there may be any number of medical devices 14 as is needed to gather all relevant patient medical information and data.

The aggregation device 22 serves as an interface between the medical device 14 and the health care provider display device 20, and may alternatively or additionally be coupled to a web application device 26. The aggregation device 22 allows one or more medical devices 14 to seamlessly connect and transmit the collected medical data from the one or more medical devices 14 to the intranet or internet 16. The aggregation device 22 may be a combination of hardware (providing appropriate physical connection between the medical devices 14 and the web application device 26, if required, although the medical devices 14 may have a USB or other physical interface to connect directly to the aggregation device 22) and software (one or more windows services or Linux daemon or other comparable services that communicate with the medical device drivers in order to be able to gather the data from the medical device 14).

The aggregation device 22 may use a configuration file 30, which identifies which medical devices 14 are or should be connected to the aggregation device 22 so that the data from the medical devices 14 can be transferred from the aggregation device/device 22/26 to the internet or intranet 16. The aggregation device 22 may work in conjunction with a windows media encoder, a flash media encoder, a VLC media encoder, or other media encoder/server in order to capture and stream data from the medical devices 14. The aggregation device 22 is preferably provided as a web 2.0 service or other similar or equivalent service. As such, web browsers and application users and other consumers of the service can interrogate the web service 25 to determine what medical devices are present, their status, and start and stop streaming and recording of medical data.

Medical devices 14 may be connected directly to the device 26 and recognized by the aggregation device 22, utilizing the configuration file 30, which eliminates teleconference equipment incompatibility problems formerly experienced with prior art systems. One feature of the present invention is the elimination of teleconference systems with the exception of the potential use of a teleconference system to provide a video and/or an audio link between the patient and the health care provider in the case of real time medical examinations in which case no medical data is provided by an or through the teleconference system but only real-time face to face audio and visual communications to provide as near an “office visit” simulation as possible. In this case, a teleconference connection or other similar audio/video connection such as utilizing Skype or other similar computer, cell phone or similar based service may be provided to allow the medical practitioner to see and speak with the patient and vice versa.

The aggregation device 22 allows for more comprehensive capture of all of a patient's medical information required for the particular patient consultation or diagnosis, as well as for accurate and complete recording of the information in the patient's medical record, if desired. Additionally, the aggregation device 22 preferably has a programmable profile, whereby if the device 26 at the clinic location 11 using the aggregation device 22 has less bandwidth due to their location or internet service provider, the aggregation device 22 can be modified to accommodate and fully function at a very low bandwidth.

The information received by the aggregation device 22 is then transmitted to the internet or intranet 16 via a wireless or wired transmission. This arrangement eliminates the need for teleconference or videoconference devices for medical information. All of the medical information that is collected is available to one or more physicians 20a, 20b or 20n who have appropriate access to the particular patient information.

The medical encounter system 10 is designed to be extremely modular, portable and customizable. The physician or other health care provider 20 can utilize the medical encounter system 10 and view medical data on a multitude of devices such as his or her office personal computer/laptop, home personal computer/laptop, even someone else's personal computer away from their home or office; any personal computer, smart phone, IPad™ or other similar device, and in short, any device capable of running a browser or application 30 including any cell phone or personal digital assistant, such as an iPhone™ or Blackberry™ that has internet or intranet access and is capable of running a browser or an application 30.

The physician 20 can access the medical information directly from the internet or intranet 16 (data storage device 18 if the data has been stored) via a wireless or wired transmission through the use of any device 20 that can run a browser 30 and runs a common operating system such as Windows, Windows CE, Linux including but not limited to a personal computer, mobile device, smartphone, kiosk, or any other processor based terminal. The physician has the flexibility to access the information simultaneously (in real time) while it is being transmitted from the patient (with or without a simultaneous audio/video connection) or at a later point in time by retrieving the information from the data storage device 18.

The physician 20 can access the medical information once or multiple times. Additionally, more than one physician 20 or other healthcare provider can access the medical information at the same time. The physician 20 does not need any special equipment or devices to access and interpret the medical information provided from the results of the tests performed by the medical devices 14, thereby eliminating the need for any decoders or other specialized equipment (such as teleconferencing systems as in the prior art) to view the medical information.

The physician(s) or other health care provider or health care assessment professional 20a, 20b or 20c have access to the medical data service 25 by means of an internet or intranet 16 through a secure connection using a user identification and password. After a physician 20 has logged onto the internet or intranet 16 through the browser 30, the physician 20 can select the particular clinic or location that they are referencing.

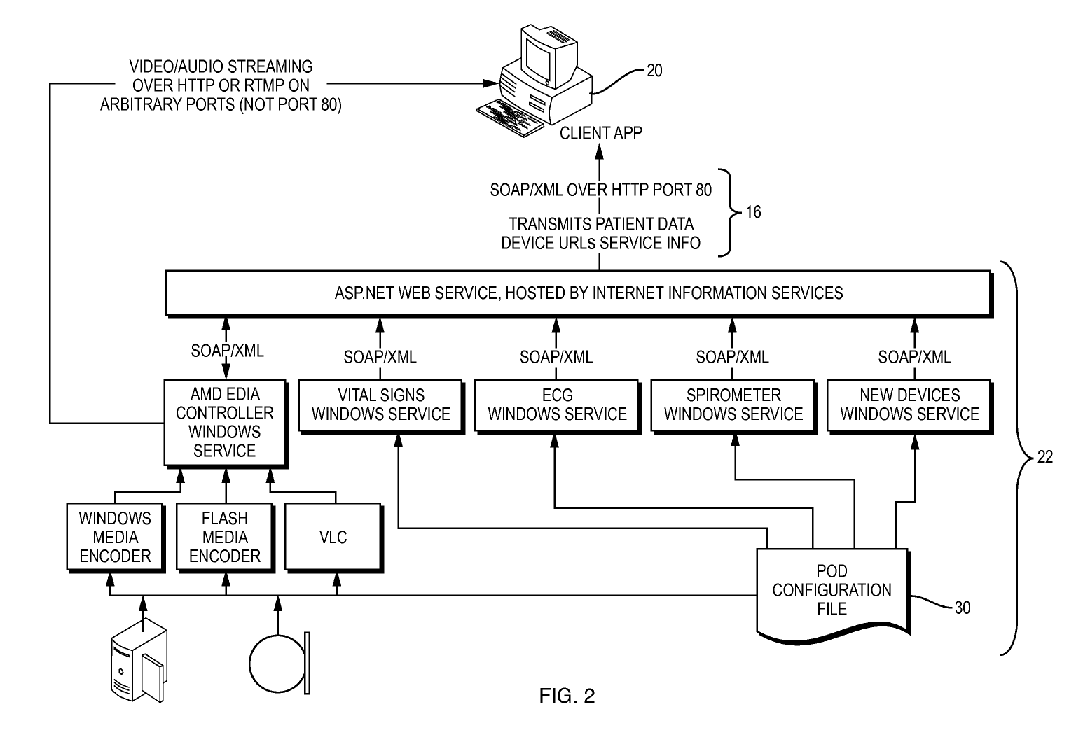

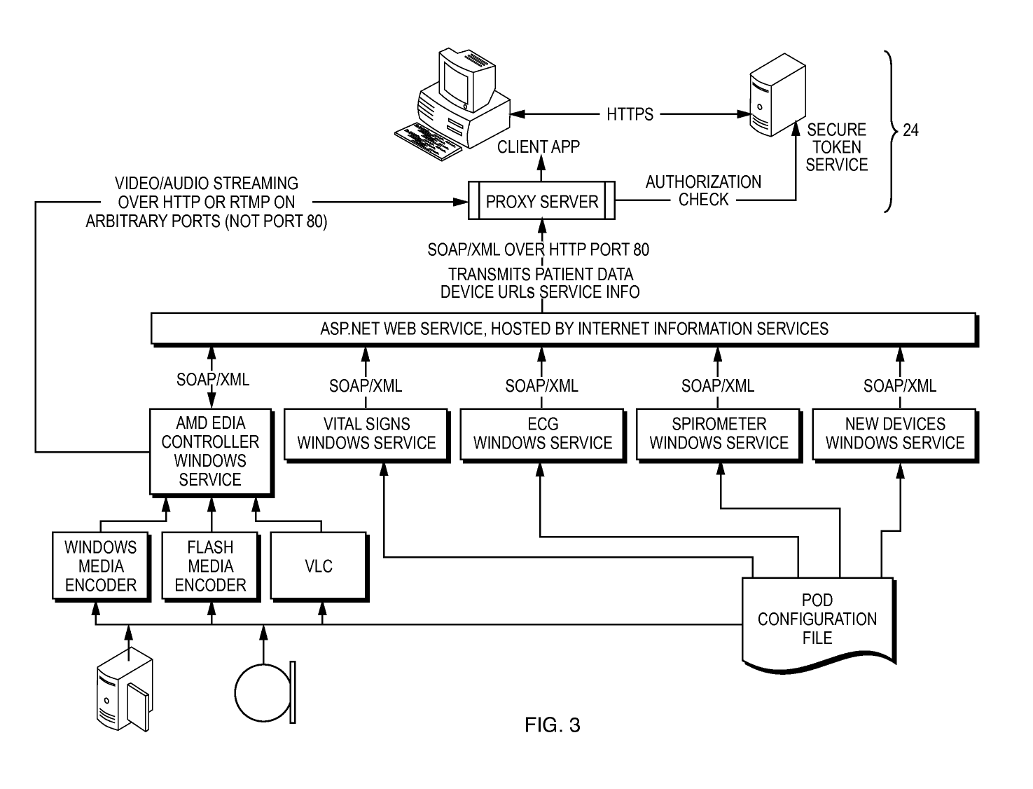

A connect manager or portal 24, FIG. 3, if provided, allows for physician authentication and for a physician 20 to monitor multiple patients 12a, 12b or 12c at multiple locations. The connect manager 24 will direct the physician 20 to the particular clinic/patient data that they choose and/or are authenticated to access based on stored IP addresses and web addresses of each clinic. This allows a physician 20 to seamlessly move from one patient in one location to another patient in a second location without having to enter new IP addresses or web addresses. Additionally, the connect manager 24 provides authentication and security features that ensure medical data is secure. Alternatively, in some circumstances, a connect manager 24 may not be necessary (see FIG. 2).

The medical encounter system 10 (sometimes called by its trademarked name “Agnes” in this disclosure and/or drawings) is designed to enable the transmission of the data collected via POTS (standard telephone) line, Ethernet, pager or wireless communications. Types of wireless data collection that are envisioned include, but are not limited to, Bluetooth, Zigbee, Radio Frequency (RF), infrared, IEEE 802.11, IEEE 802.15, IEEE 802.16 and IEEE P1451.5. The collected data is then immediately made available via a secure or un-secure web access on the internet or intranet 16.

The medical encounter system 10 also allows various client and physician profiles to be fully customizable and programmable through the internet or intranet 16. As a result, if a client or physician is located in an area that does not feature a high-speed internet connection, the display or transmission of the medical results can be modified to accommodate very low bandwidths (albeit perhaps a smaller picture or view), thereby allowing for transmission of medical results no matter where the client or physician is located and no matter what type or speed of their internet connection.

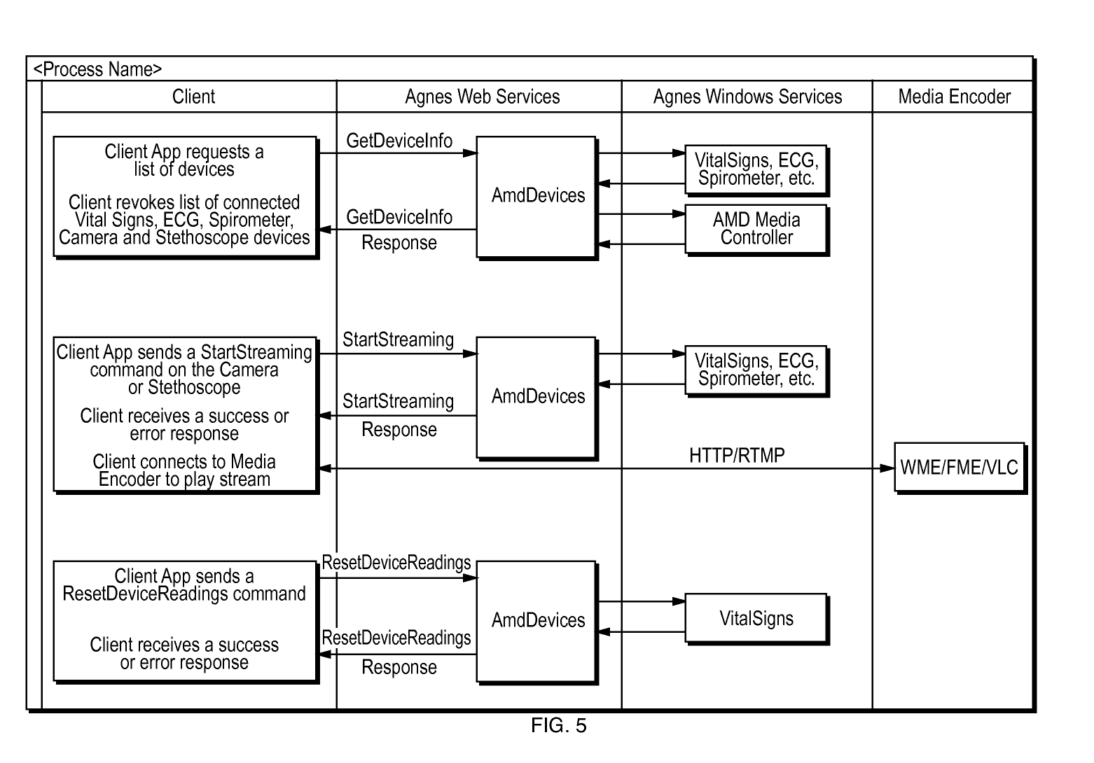

The following is a simplified step by step operation of the device aggregator 22. For example, for a stethoscope medical device 14, the following assumes a stethoscope audio is connected to an audio input of the device aggregator 22 using an appropriate connector, if required, and that the aggregator device has an appropriate driver for the stethoscope medical device 14. See FIG. 5 for a block diagram.

A client (web application or device application) interrogates the web service to see if the stethoscope is supported. The devices service checks the configuration file 30 to see if supported and responds to the request appropriately. After determining it is supported, the client issues a start streaming command. The Devices web service then communicates to the media controller windows service and either starts a media encoder or instructs the media encoder to start streaming the audio. The client then interrogates the web service to ascertain that the audio is streaming and how to consume the stream. The client application then attaches to the stream using the appropriate protocol and decoding. Essentially the same process is followed for video as well.

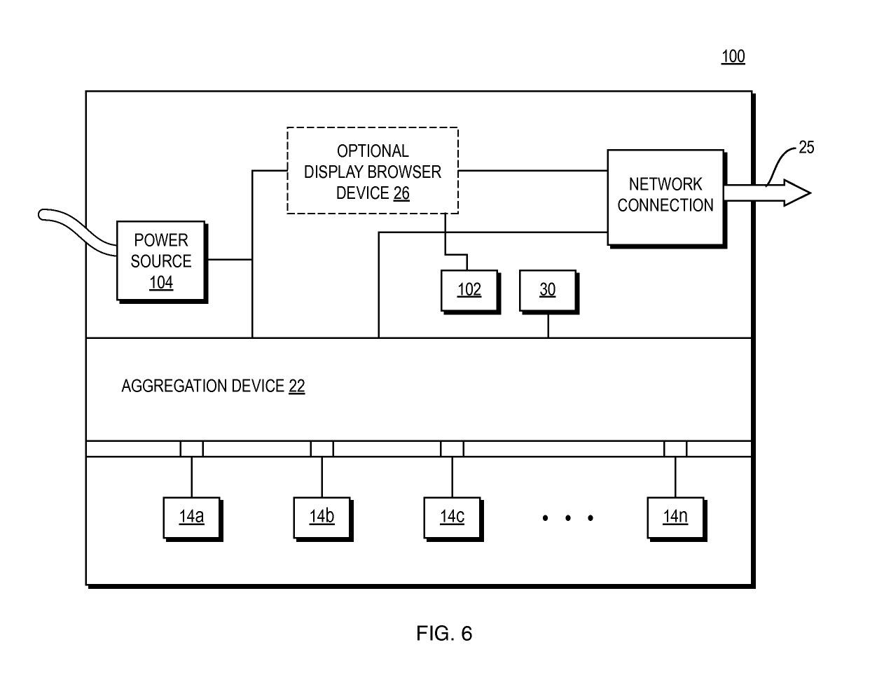

In another embodiment of the present invention, at least a portion of the internet/intranet and browser based remote medical encounter system 10 may be self-contained within a portable device or “suitcase” or kit 100, FIG. 6. The kit 100 can be customized for use by a particular patient or group of patients or population or geographic area being served or medical profession type (a kit could be designed for dentistry; one for heart care; one for skin care: etc.). In a preferred embodiment of the present invention, the kit 100 will contain one or more medical devices 14 (or a connection to one or more external medical devices 14), a device running a browser 26 and an aggregation device 22. Additionally, the kit 100 may include an “on-line” instruction or operations manual 102. The kit 100 may also include a power source (such as a battery or solar cell) or a power source adapter 104. The kit 100 will also include internet or intranet connection capability 105 via a wireless or wired connection. The kit 100 will serve to contain all of the individual pieces that are necessary to operate the patient end of the medical records system 10. The kit 100 will be designed in a highly efficient and portable manner, such that each component contained within the kit is secured and organized.

Accordingly, the present invention provides a novel medical data collection method and system for assembling medical data from an individual when the individual is located remotely from a healthcare professional. A computer type device that includes an aggregation device is used at the patient remote site for collecting medical data/information from various medical devices that can gather appropriate medical data. The aggregation device sends the recorded medical data as a service to an internet or intranet. The information may be saved on a local or centralized data storage device and/or stored to a patient's medical record. A healthcare provider (i.e. physician, physician's assistant, nurse or the like) can access the medical data from the data storage via a connect manager or through a secure or unsecure web connection in real time while the data is being captured from the patient or if the data is stored, at any time in the future using a personal computer or handheld device such as a personal computer, notebook, palm pilot, Iphone, Blackberry or the like that is capable of running a web browser that can consume the medical record service provided by the aggregation device.

The present invention is not intended to be limited to a device or method which must satisfy one or more of any stated or implied objects or features of the invention and should not be limited to the preferred, exemplary, or primary embodiment(s) described herein.

Modifications and substitutions by one of ordinary skill in the art are considered to be within the scope of the present invention, which is not to be limited except by the allowed claims and their legal equivalents.

What is claimed is:

1. A system for collecting medical data directly from a patient and for making the collected medical data available over a network connection to one or more medical personnel using a display device capable of operating a web browser/application and located remotely from said patient, said system comprising:
one or more medical information gathering devices;
a medical information gathering device aggregation apparatus, electronically coupled to each of said one or more medical information gathering devices, and configured for receiving medical data from each said one or more electronically coupled medical information gathering devices, and responsive to said received medical data, for providing a real time consumable web service/application including said received medical data to a network connection; and
one or more medical data display devices, located remotely from said one or more medical information gathering devices and said medical information gathering device aggregation apparatus, and configured for being coupled to said network, said one or more medical data display devices configured for receiving and consuming said real time consumable web service/application including said medical data provided by said medical information gathering device aggregation apparatus.

2. The system of claim 1, wherein said network connection is selected from the group consisting of an intranet connection and a internet connection.

3. The system of claim 1, wherein said real time consumable web service/application are web services consumed directly from a web browser.

4. The system of claim 1, wherein said real time consumable web service/application are said web services consumed by a web application to be formatted and then consumed by a web browser.

5. The system of claim 1, wherein said real time consumable web service/application is a Service Oriented Architecture (SOA) web service.

6. The system of claim 1, wherein said medical information gathering device aggregation apparatus is electronically coupled to said one or more medical information gathering devices by one of a wired connection and a wireless connection.
